(19) United States
(12) Patent Application Publication
(10) Pub. No.: US 2007/0032322 A1
(43) Pub. Date: Feb. 8, 2007

(54) Hydraulic chain tensioner assembly

(76) Inventor: John M. Beardmore, Howell, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/198,552

(22) Filed: Aug. 5, 2005

(51) Int. Cl. F16H 7/08; F16H 7/22

(52) U.S. Cl. 474/110; 474/101

(57) ABSTRACT

A hydraulic chain tensioner assembly includes a plunger slider received within an opening in a tensioner body to define a controlled clearance and a substantially fluid-tight chamber. Pressure in a supply reservoir that is in fluid communication with the fluid-tight chamber is controlled to a relatively low level by appropriate sizing of the feed orifice and a bleed orifice in communication with the supply reservoir. Thus, apply force of a shoe connected to a plunger on a chain is a function of stiffness of a main spring that biases the plunger outward, and is not substantially affected by pressure of a fluid source supplying fluid to the reservoir. A method of manufacturing a hydraulic chain tensioner assembly is also provided.

### TECHNICAL FIELD

This invention relates to a hydraulic chain tensioner assembly including a fluid-tight chamber connected to a pressure-controlled supply reservoir.

### BACKGROUND OF THE INVENTION

The chain drive has emerged as the preferred means of operating ancillary components within the modern automotive engine. For example, chain drives have been employed to drive complex valve trains, balance shafts, oil pumps, high pressure fuel injection pumps and water pumps. A dedicated tensioning device has become a virtual necessity to ensure the overall functional performance of a chain drive given the advent of increasing packaging complexity and its influence on chain drive layout and design. Over time, a chain may slacken due to repeated loading and unloading cycles during torque reversal. Hydraulic chain tensioner assemblies must strike a balance in imposing an apply force sufficient to tighten a slack chain to ensure chain functionality, while minimizing chain noise. Noise caused by high apply loads may be referred to as “whine” and “whiz” and is due to abrupt and impulsive engagement and disengagement of the sprocket teeth with successive links of the chain. When tensioner reaction loads are too low, a rattle or clatter noise of the chain impacting against the sprockets and guides occurs.

### SUMMARY OF THE INVENTION

A hydraulic chain tensioner assembly is provided that achieves low apply loads to minimize whine and whiz noise but is very stiff in reactive loading, which maintains control of the chain while minimizing clatter or rattle type noise.

A hydraulic chain tensioner assembly includes a shoe configured to contact an endless chain. The tensioner body has an opening, which is preferably bored and honed to size, and a plunger is slideably received within the opening. The plunger is connected to the shoe. The plunger and the opening are sized to define a controlled and substantially tight clearance therebetween. The plunger and the opening also at least partially define a substantially fluid-tight chamber. A spring biases the plunger outward from the opening. The tensioner body also has a supply reservoir that is in fluid communication with a fluid source and is also in selective fluid communication with the chamber via a check valve which maintains a fluid column within the chamber. Pressure of fluid in the supply reservoir is substantially independent of the pressure and pressure variations of the fluid source. Notably, an apply force of the shoe upon the chain is a function of stiffness of the spring and not of the pressure of the fluid source. Thus, the hydraulic chain tensioner assembly enables a well-controlled apply force to the chain that is not influenced by pressure variations in the fluid source.

In one aspect of the invention, structure (such as the tensioner body) forms a feed orifice by which fluid communication occurs between the fluid source and the supply reservoir. Other structure, such as a cup plug placed in an opening in the tensioner body above the reservoir, forms a bleed orifice to vent air from the reservoir. The feed and bleed orifices are sized to control pressure of fluid within the supply reservoir.

In another aspect of the invention, the feed orifice is characterized by a first diameter that is larger than a second diameter of the bleed orifice. This enables a substantially constant slight pressurization within the supply reservoir. The feed orifice diameter may also be slightly smaller than the bleed orifice diameter, in which case the reservoir pressure will be the same as that downstream of the bleed orifice (e.g., atmospheric pressure).

In one aspect of the invention, an air vent valve is in communication with the fluid chamber to vent air therefrom, thereby causing the fluid column within the chamber to be substantially air-free and to have a hydraulic stiffness that substantially prevents inward movement of the shoe when under loading by the chain. Preferably, the air vent valve is a piddle valve which enables air, but not the more viscous fluid within the chamber, to vent therefrom.

In one embodiment, a plug is positioned in the opening or bore opposite the shoe. The plug is sized to further define the fluid-tight chamber. The check valve is positioned on the plug. The plug has an integral passage by which the supply reservoir is in fluid communication with the check valve. The plug is press-fit into the opening. The plug may also have an annulus between the integral passage and the supply reservoir.

In yet another embodiment, the plunger defines an internal reservoir between the supply reservoir and the chamber. The plunger may have a fill opening and may at least partially form an annular opening in fluid communication between the supply reservoir and the internal reservoir.

In one aspect of the invention, the check valve permits flow into the fluid chamber when the plunger moves outward, which occurs when force from the spring overcomes force of the chain against the shoe. Additionally, the clearance, check valve and air vent valve permit the fluid-filled chamber to provide a substantially static reaction load when loaded by the chain. This is possible because the clearance between the plunger and the opening is preferably so small that the leak down time of the plunger is extremely long. Thus, the hydraulic chain tensioner assembly supplies a relatively low apply force to take up slack from the chain, the apply force not being influenced by system pressure, and yet provides a very stiff reaction load.

A method of manufacturing a hydraulic tensioner assembly includes providing a tensioner body having a reservoir. The method further includes boring an opening through the tensioner body. Furthermore, the method includes machining a first passage in a plug member. A second passage is then machined to intersect the first passage. A check valve is then seated at the second passage. Finally, the plug member and seated check valve are pressed in one end of the opening. Preferably, the method also includes honing the bored opening and sliding a plunger into an opposing end of the opening to then define a chamber with the opening.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a balance shaft drive layout with a first embodiment of a hydraulic chain tensioner assembly contacting a chain;

FIG. 2 is a cross-sectional view of the hydraulic chain tensioner assembly of FIG. 1;

FIG. 3 is a graphical illustration of chain noise (dBA) versus engine speed (rpm) under apply loading by a typical prior art chain tensioner assembly and the chain tensioner assembly of FIGS. 1 and 2;

FIG. 4 is a graphical illustration of lateral acceleration (m/s²) of a chain versus engine speed (rpm) during reaction loading of another typical prior art chain tensioner assembly and the chain tensioner assembly of FIG. 1 and 2;

FIG. 5 is a second embodiment of a hydraulic chain tensioner assembly within the scope of the invention; and

FIG. 6 is a third embodiment of a hydraulic chain tensioner assembly within the scope of the invention.

### DESCRIPTION OF THE PREFERRED EMBODIMENTS

Referring to the drawings, wherein like reference numbers refer to like components, FIG. 1 shows an engine 10 which has a hydraulic chain tensioner assembly 12 tensioning a balancer drive chain 14. It is noted that, while the hydraulic chain tensioner assembly 12 is applied to a balancer drive layout of FIG. 1, the hydraulic chain tensioner assembly 12 may alternatively be applied to tension to a valve train drive, as is understood by those skilled in the art. A crank sprocket 16 powered by the engine 10 and rotating at engine speed drives the balancer chain 14 which rotates counter shaft sprockets 18A and 18B to drive balance shafts connected thereto (balance shafts not shown). The layout of the crank sprocket 16 and balance sprockets 18A, 18B requires packaging the hydraulic chain tensioner assembly 12 as shown, which means that it contacts the chain 14 at a relatively short span thereof. Tensioning the chain 14 over such a short span increases the potential for noise caused by the interaction of the chain with the sprockets 16, 18A, 18B.

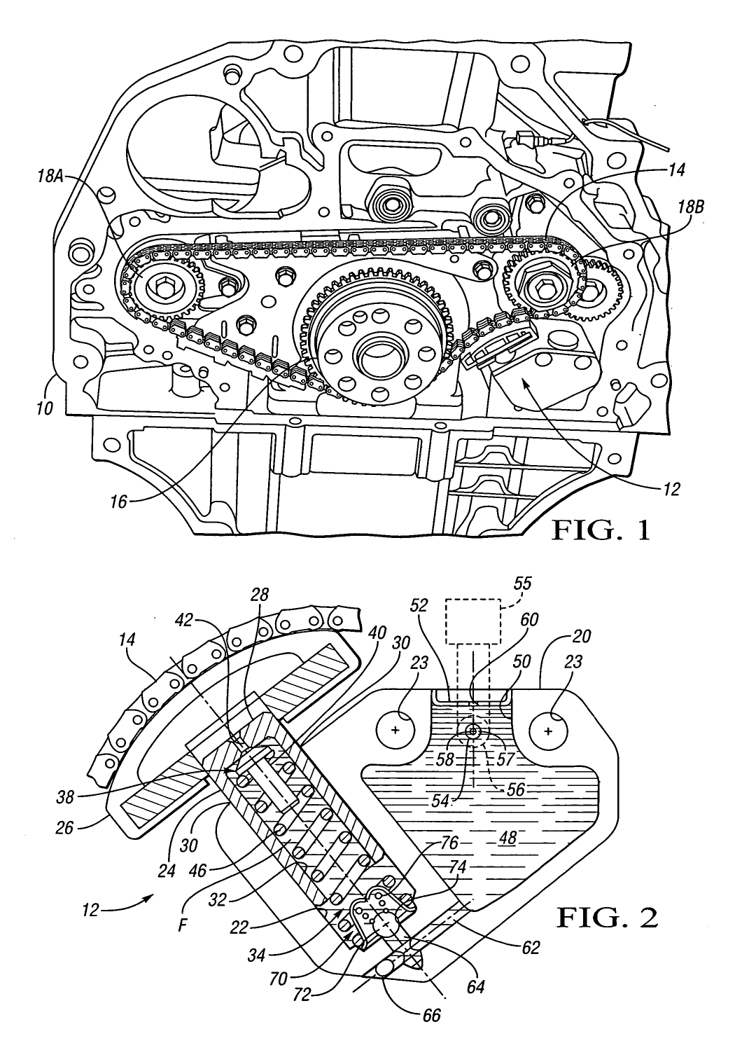

Referring to FIG. 2, the hydraulic chain tensioner assembly 12 of FIG. 1 is shown in cross-sectional detail. The hydraulic chain tensioner assembly 12 includes a tensioner body 20. The tensioner body 20 has an opening 22 which is preferably bored and honed in the body 20. Attachment hole openings 23 are drilled or otherwise formed in the tensioner body 20 for receiving attachment mechanisms such as bolts to attach the hydraulic chain tensioner assembly 12 to the engine 10 of FIG. 1. A plunger 24 is slideably positioned within the bore 22. A shoe 26 is connected at a distal end 28 of the plunger 24 for contact with the chain 14. The diameter of the plunger 24 and the diameter of the bore 22 create a controlled diametral clearance 30 between the plunger 24 and the bore 22. The controlled clearance 30 is preferably two to eight micrometers (μm). To attain the controlled clearance 30, both the bore 22 and the plunger 24 must be of a ferrous material. The bore 22 and the plunger 24 must be hardened and ground smooth to precision surface specifications. The manufacturing of such a plunger and bore is similar to that of a hydraulic valve lifter, which is mass produced at a modest cost.

The plunger 24 has an inner opening 32 which may be bored or otherwise formed therein. The inner opening 32 and the bore 22 in the tensioner body 20 cooperate to define a chamber 34. As will be further described below, the chamber 34 is substantially fluid-tight and, when filled with fluid, is characterized by a hydraulic stiffness that substantially prevents inward movement of the shoe 26 when under loading by the chain 14. The hydraulic stiffness (k) of a fluid or oil column F in the chamber 34 Is define by the following formula:
k=[B *A]/L;
where B=bulk modulus of the fluid or oil, A=plunger cross-section area, and L=effective oil column length (or height). Within the hydraulic chain tensioner assembly 12 of FIG. 2, the fluid essentially fills the chamber 38 and the fluid column length is essentially the same as the length of the chamber 38 measured between the plunger 24 and the bottom of the bore 22, parallel to the length of the bore 22.

Oil column stiffness k is highly dependant upon the aeration state of the oil. Even a small amount of air entrained within the oil causes the bulk modulus to significantly decrease. Accordingly, the hydraulic chain tensioner assembly 12 preferably includes an air vent valve 38 which includes a valve member 40 that seats within an opening 42 at the distal end 28 of the plunger 24. Preferably, the air vent valve 38 is a “piddle” or “burp” valve of a small poppet-like configuration that is held against the vent opening 42 by a main spring 46. Other types of valves will accomplish the same goal as a piddle type valve, which is to vent any entrained air within the chamber 34. Entrained air within the chamber 34 will migrate to the high end of the plunger 24. The valve member 40 is free to jiggle, or vibrate, at the opening 42 which allows entrained air to escape, but remains substantially seated to prevent higher viscosity oil from exiting through the opening 42.

Tensioner body 20 is formed with a cavity 48 which may be referred to herein as a supply reservoir. The supply reservoir 48 is preferably cast in the tensioner body 20. An upper opening 50 of the reservoir 48 is capped by a cup plug 52, which creates a leak free closure.

The tensioner body 20 is machined as formed with a feed port 54 which is in fluid communication with a fluid supply passage 56 from the main oil gallery 55 (i.e., a fluid source) of the engine 10. A feed port cup plug 57 seals the feed port 54. The feed port 54 should be located within the upper most region of the reservoir 48 for maximum retained volume for when the engine 10 is shut down and then restarted. Oil flows through the fluid supply passage 56 to the feed port 54. The fluid supply in the fluid supply passage 56 is pressurized by a pump (not shown), as is well understood by those skilled in the art. A feed orifice 58 in the cup plug 57 controls fluid flow into the reservoir 48. A bleed orifice 60 is formed in the plug 52 and is utilized to vent air from the supply reservoir 48. The bleed orifice 60 should also be located at the top of the reservoir 48 to maximize the reservoir volume for optimal venting of entrained air.

The feed orifice 58 and the bleed orifice 60 are sized to create a “feed/bleed” system. The term “feed/bleed” system means a system designed for controlled charging or supply and controlled discharge across a hydraulic element, such as the reservoir 48. The feed orifice 58 essentially controls the net flow into the reservoir 48. The bleed orifice 60 affects the pressure within the reservoir 48. For feed orifice diameter/bleed orifice diameter >1.0, there will be some governed pressure within the reservoir 48 higher than atmospheric (assuming the bleed orifice 60 is vented to atmosphere). For feed orifice diameter/bleed orifice diameter <1.0, the pressure within the reservoir 48 will only attain the pressure downstream of the bleed orifice 60, i.e., with the bleed orifice 60 vented to atmospheric pressure, the reservoir 48 can only attain atmospheric pressure.

Accordingly, in one embodiment, the feed orifice 58 is preferably one to two millimeters (mm) in diameter and the bleed orifice 60 is preferably approximately 2 mm in diameter. Thus, the bleed orifice 60 is at least the same diameter or is a greater diameter as the feed orifice 58. The sizing of the orifices 58, 60 enables a very low reservoir pressure, ideally on the order of 35 kilopascals (kPa) or less (5 pounds per square inch (psi)). Notably, the restriction of the feed orifice 58 creates a pressure drop from the fluid supply passage 56. Alternatively, the ratio of feed orifice diameter/bleed orifice diameter may be slightly greater than 1.0 to affect a very slight pressurization of the reservoir 48 (as described above). (The unseating pressure differential of a check ball valve assembly 70, described below, is designed to coordinate with the chosen ratio of feed orifice diameter/bleed orifice diameter.) A very slight pressure in the reservoir 48 will still yield desired operation. This reservoir pressure is still substantially lower than gallery feed pressure and with less variation. In fact, changes in pressure of the oil supply in the passage 56 are not communicated to the fluid in the supply reservoir 48 due to controlled feeding through the feed orifice 58 and venting of air through the bleed orifice 60 which controls pressure in the reservoir 48.

Within the scope of the invention, alternative reservoir designs may be utilized. For instance, the reservoir may be an “open hopper” design in that the opening 50 at the top of the reservoir 48 may be left open, not closed off by cup plug 52 (i.e., no cup plug 52 is necessary in an “open hopper” design). The opening 50 is positioned upward to catch splashed fluid within the engine 10. (The splashed fluid is delivered from the fluid source and is used for splash cooling of the engine.) No fluid supply passage 56, feed port 54, or feed and bleed orifices 58, 60, respectively, are required. Because the reservoir 48 is open, fluid within the reservoir will be at atmospheric pressure. The opening 50 may also be enlarged to catch fluid over a greater area. A debris screen may be required at the opening 50 to prevent debris from plugging the supply reservoir 48.

First and second fluid passages 62, 64, respectively, are drilled, bored or otherwise created in the tensioner body 20 such that they intersect and the first fluid passage 62 opens to the supply reservoir 48. A seal member 66 seals an end of the first fluid passage 62 opposite the supply reservoir 48. Preferably the first and second fluid passages 62, 64 are located near a bottom portion of the supply reservoir 48 such that gravity feeds fluid from the reservoir 48.

A one way check ball valve assembly 70 is positioned between the fluid-tight chamber 34 and the second fluid passage 64. A check ball 72 is seated on a valve seat 74. The check ball 72 and valve seat 74 are of a “zero leak” design. A check ball spring 76 biases the check ball 72 against the valve seat 74. The check ball spring 76 has a stiffness that allows the check ball 72 to unseat from the valve seat 74 at a very slight pressure differential in the fluid-tight chamber 34. Thus, a slight outward movement of the plunger 24 unseats the check ball 72 and allows fluid to enter the fluid-tight chamber 34 through the first and second fluid passages 62, 64 from the reservoir 48. Thus, whenever slackness develops within the chain 14, the main spring 46 moves the plunger 24 outward; as the plunger 24 extends, the check ball 72 immediately lifts or “unseats” to draw in oil from the supply reservoir 48. The “push” or “apply” force of the plunger 24 and shoe 26 against the chain 14 is dictated principally by the force calibration “i.e. the spring stiffness” of the main spring 46 and is not influenced by engine oil pressure to a large degree (as it is with conventional art). Conversely, when the chain 14 tightens, the reaction force from the plunger 24 and shoe 26 will be dictated by the essentially air-free, fluid-filled column F within the chamber 34. The air-free fluid column F has a hydraulic stiffness k (described above) that substantially prevents inward movement of the shoe 26 and plunger 24 when loaded by the chain 14.

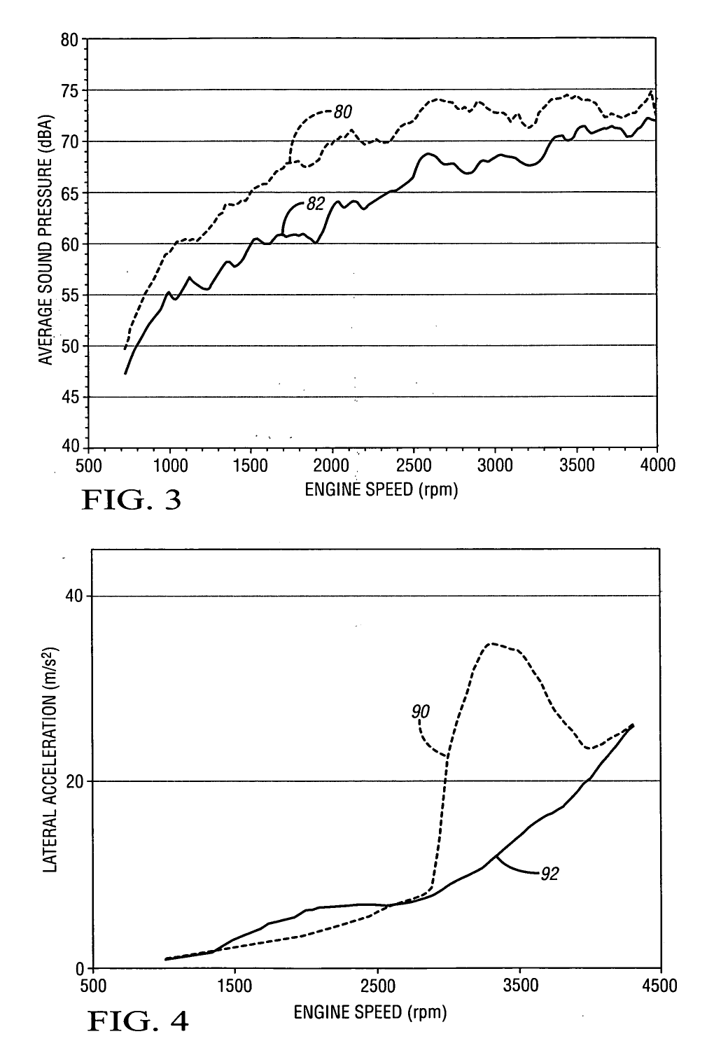

Referring to FIG. 3, data reflecting chain whine noise from a typical prior art hydraulic chain tensioner is plotted as curve 80, measured in sound pressure (dBA) versus engine speed (rpm). The typical prior art tensioner resulting in whine noise shown by 80 has a 15 Newton spring, a check valve and a leak down time of 11.5 seconds. The chain whine noise produced by the hydraulic chain tensioner assembly 12 of FIG. 2 is shown at 82. As FIG. 3 makes clear, the hydraulic chain tensioner assembly described herein exhibits lower chain whine noise than the typical prior art hydraulic chain tensioner assembly. This is due at least in part to the very low apply load imparted by the hydraulic chain tensioner assembly described herein.

Referring to FIG. 4, a comparison of lateral acceleration of a chain when applying force to a typical prior art hydraulic chain tensioner assembly, is shown at 90, and when applying force to the hydraulic chain tensioner assembly described herein as shown at 92. The lateral acceleration of FIG. 4 is a qualitative measure in m/s² of the engine block's vibration response to that generated principally by the chain drive. Any misbehavior of the chain will ultimately be manifest as rattle, slap, or clatter-like noise. Thus, when the hydraulic chain tensioner assembly cannot withstand reaction loading imparted by the chain, the chain will operate in an uncontrolled manner. As a consequence, the chain will ‘thrash’ about impulsively causing high vibration as measured externally on the engine block by the accelerometer. As shown in FIG. 4, the typical prior art hydraulic chain tensioner assembly has higher lateral acceleration over much of the engine speed range, as exhibited at 90, than the hydraulic chain tensioner assembly of the invention, as exhibited at 92. Prior art hydraulic chain tensioner assemblies are not capable of exhibiting both lower whine noise (82 in FIG. 3) and low lateral acceleration (92 in FIG. 4) as does the hydraulic chain tensioner assembly described herein, due its ability to apply force to the chain with a very light load and to withstand loading by the chain with the very steady reaction load. Typically, prior art hydraulic chain tensioner assemblies sacrifice either the low whine noise during apply load or the low lateral acceleration during reaction loading and do not achieve low values in each.

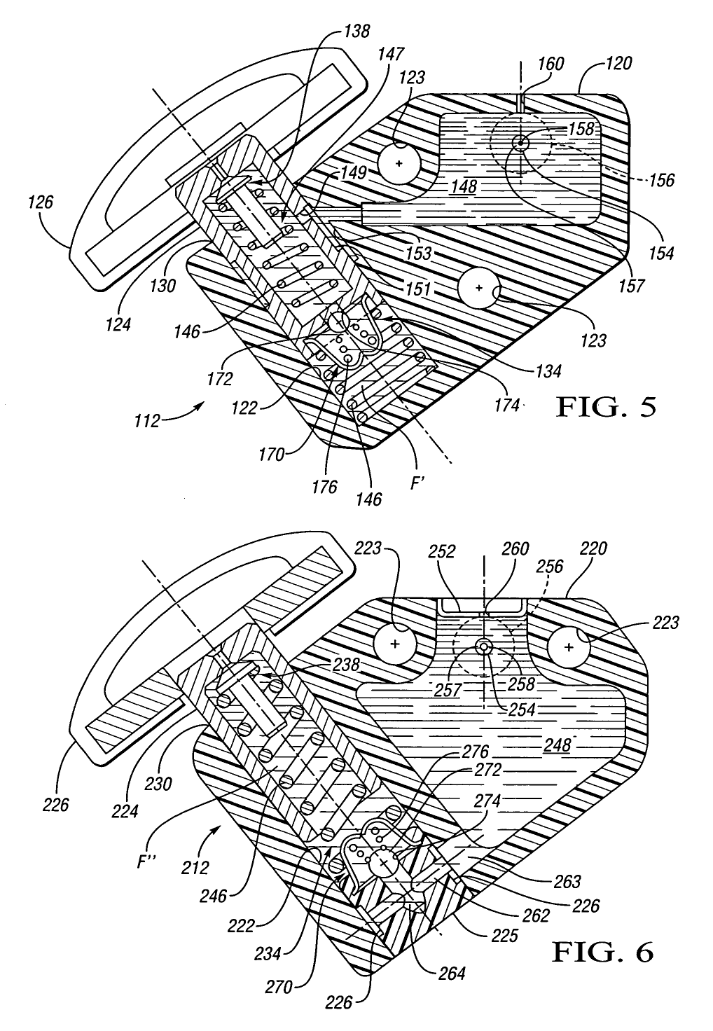

Referring to FIG. 5, a second embodiment of a hydraulic chain tensioner assembly 112 is shown. Attachment hole openings 123 are drilled or otherwise formed in the tensioner body 120 for receiving attachment mechanisms such as bolts to attach the hydraulic chain tensioner assembly 112 to an engine as in well understood by those skilled in the art. The hydraulic chain tensioner assembly 112 includes a tensioner body 120 having an opening or bore 122 with a plunger 124 slideably received therein to define a fluid-tight chamber 134, with a main spring 146 biasing the plunger 124 outward. The plunger 124 and the opening 122 are relatively sized to define a controlled diametral clearance 130 therebetween that is on the order 2 to 8 μm, thereby establishing the fluid tightness of the chamber 134. A fluid column F′ within the chamber 138 extends between the bottom of the plunger 124 and the bottom end of the bored opening 122, on which the spring 146 is seated. The plunger 124 defines an internal reservoir 147 which is in fluid communication with a supply reservoir 148 formed in tensioner body 120. A fill opening 149 and an annular opening 151 in the plunger 124 ensures fluid communication between the internal reservoir 147 and the supply reservoir 148. The annular opening 151 runs part way along the length of the plunger 124 adjacent an annular opening 153 in tensioner body 120 to ensure fluid communication as the plunger 124 moves relative to the tensioner body 120.

A fluid passage 156 from the main oil gallery is in fluid communication with the supply reservoir 148 through a feed orifice 158 formed in a cup plug 157 positioned at a feed port 154 machined or formed in the tensioner body 120. A bleed orifice 160 is drilled or otherwise formed in the tensioner body 120 at a top portion of the supply reservoir 148. The bleed orifice 160 is preferably at least as large as the feed orifice 158 to maintain a relatively low pressure in the supply reservoir 148, as described with respect to the embodiment of FIG. 2, which is less than the supply pressure from the fluid passage 156.

A one way check ball valve assembly 170 is seated between the fluid-tight chamber 134 and the plunger 124. A check ball 172 is seated against a valve seat 174 by a check ball spring 176. When a main spring 146 biases the plunger 124 outward as slack develops in a chain contacting a shoe 126 at the end of the plunger 124 (chain not shown), the check ball 172 unseats, allowing fluid to flow from the internal reservoir 147 to the fluid-tight chamber 134 at the slightest pressure differential across the check ball valve assembly 170. Fluid from the supply reservoir 148 replenishes the fluid in the internal chamber 147. Because the air vent valve 138 is disposed within the internal reservoir 147 and the supply reservoir 148 fluidly connects with the internal reservoir 147, any entrained air will be vented through the air vent valve 138 and will not reach the fluid-tight chamber 134, thereby maintaining a fluid column F′ therein that maintains stiffness under reaction loading to minimize rattle and clatter of the contacting chain (not shown).

Referring to FIG. 6, a third embodiment of a hydraulic chain tensioner assembly 212 is depicted. Tensioner body 220 has an opening 222 or bore which receives a slideable plunger 224 therein. A shoe 226, plunger 224, air vent valve 238, and a main spring 246 are similarly constructed as like components in FIG. 2. Additionally, a supply reservoir 248 having a feed port 254 with a feed port cup plug 257 and a feed orifice 258 therein positioned at a fluid supply passage 256, as well as a cup plug 252 with a bleed orifice 260 therein are similarly constructed as like components of FIG. 2. Attachment hole openings 223 are drilled or otherwise formed in the tensioner body 220 for attaching the hydraulic chain tensioner assembly 212 to an engine.

Unlike the opening of bore 22 of FIG. 2, the opening 222 of FIG. 6 is bored completely through the tensioner body 220. A plug 225 is pressed in an end of the opening 222 opposite the shoe 226 to close off the opening 222 thereby defining with the opening 222 and the plunger 224 a fluid-tight chamber 234. A fluid column F″ extends the length of the chamber 238 between the plunger 124 and the inner side of the plug 225, on which the spring 246 is seated, parallel to the length of the bore 222. The plug 225 incorporates a check valve assembly 270 seated thereon as well as first and second integral passages 262, 264, respectively, drilled or otherwise formed in the plug 225. The entire assembly of plug 225 check valve 270 and integral passages 262, 264 may be preassembled and simply press-fit in the end of the opening 222, thereby potentially reducing assembly time for the hydraulic chain tensioner assembly 212. The first integral passage 262 is adjacent to a flow passage 263 formed in the tensioner body 220 to fluidly connect with the supply reservoir 248. An outer diameter annulus 226 in the plug 225 encompasses the passage 262. The annulus 226 allows the plug 225 to be pressed into position without having to orient the first integral passage 262 with respect to the flow passage 263.

A spring 276 with characteristics having an appropriate spring stiffness unseats the check ball 272 from a valve seat 274 when the plunger 224 moves outward during slackening of a chain (not shown) abutting the shoe 226. Thus, fluid from the supply reservoir 248 immediately flows into the chamber 234 to maintain the hydraulic stiffness of the chamber 234.

A method of manufacturing a hydraulic chain tensioner assembly, described with respect to the structure of FIG. 6, includes providing a tensioner body 220 having a reservoir 248. The method also includes boring and honing an opening 222 through the tensioner body 220. The method includes machining a first passage 262 in a plug member 225 as well as machining a second passage 264 that intersects the first passage. A check valve assembly 270 is then seated at the second passage 264. Finally, the plug member 225 and seated check valve assembly 270 are pressed in an end of the opening 222. A plunger 224 is then slid into an opposing end of the opening 222.

The various hydraulic chain tensioner assemblies described above provide an optimal combination of low apply load and stiff reaction loading, enabling a reduction in both chain whine noise and chain rattle and clatter. The very tight plunger to bore clearance of each embodiment affords a very long leak down time of fluid within the fluid-tight chamber. Additionally, variations in fluid supply pressure are divorced from pressure in the supply reservoir through the controlled sizing of the feed orifice and bleed orifice. Thus, apply force of the hydraulic chain tensioner assemblies described above is closely controlled by choosing a main spring with an appropriate stiffness.

While the best modes for carrying out the invention have been described in detail, those familiar with the art to which this invention relates will recognize various alternative designs and embodiments for practicing the invention within the scope of the appended claims.

1. A hydraulic chain tensioner assembly comprising:
a shoe configured to contact an endless chain;
a tensioner body having an opening and a supply reservoir;
a plunger slidably received within said opening and operatively connected to said shoe, wherein said plunger and opening are sized to define a controlled clearance therebetween and at least partially defining a substantially fluid-tight chamber;
a spring biasing said plunger outward from said opening; and
said supply reservoir being in fluid communication with a fluid source and also being in selective fluid communication with said chamber via a check valve to maintain a fluid column within said chamber;
wherein pressure of fluid in said supply reservoir is substantially independent of pressure of said fluid source so that an apply force of said shoe upon said chain is a function of stiffness of said spring and not of said pressure of said fluid source.

2. The hydraulic chain tensioner assembly of claim 1, wherein said supply reservoir has an opening positioned to collect splashed fluid.

3. The hydraulic chain tensioner assembly of claim 1, further comprising:
structure forming a feed orifice by which said supply reservoir fluidly communicates with said fluid source; and
structure forming a bleed orifice to vent air from said reservoir;
wherein said feed and bleed orifices are sized to control pressure of fluid within said supply reservoir.

4. The hydraulic chain tensioner assembly of claim 3, wherein said feed orifice is characterized by a first diameter; and wherein said bleed orifice is characterized by a second diameter smaller than said first diameter.

5. The hydraulic chain tensioner assembly of claim 3, wherein said feed orifice is characterized by a first diameter, and wherein said bleed orifice is characterized by a second diameter larger than said first diameter.

6. The hydraulic chain tensioner assembly of claim 1, further comprising:
an air vent valve in communication with said fluid chamber to vent air from said fluid chamber, thereby causing said fluid column within said chamber to be substantially air-free and to have a hydraulic stiffness that substantially prevents inward movement of said shoe when under loading by said chain.

7. The hydraulic chain tensioner assembly of claim 6, wherein said air vent valve is a piddle valve.

8. The hydraulic chain tensioner assembly of claim 1, further comprising:
a plug positioned in said opening opposite said shoe and sized to further define said fluid-tight chamber; wherein said check valve is positioned on said plug; and wherein said plug has an integral passage by which said supply reservoir is in fluid communication with said check valve.

9. The hydraulic chain tensioner assembly of claim 8, wherein said plug has an annulus between said integral passage and said supply reservoir.

10. The hydraulic chain tensioner assembly of claim 1, wherein said plunger defines an internal reservoir between said supply reservoir and said chamber.

11. The hydraulic chain tensioner assembly of claim 10, wherein said plunger has a fill opening and at least partially forms an annular opening in fluid communication between said supply reservoir and said internal reservoir.

12. A hydraulic chain tensioner assembly comprising:
a shoe configured to contact an endless chain;
a tensioner body having an opening and a reservoir;
a plunger slidably received within said opening, said plunger and opening being sized to define a clearance therebetween and a substantially fluid-tight, fluid-filled chamber, said plunger having a distal end operatively connected to said shoe;
a spring biasing said plunger outward from said opening;
said reservoir being in fluid communication with a pressurized fluid source via a feed orifice and with said fluid chamber via a check valve that permits flow into said fluid chamber when said plunger moves outward, said reservoir having an air bleed orifice cooperating with said feed orifice such that a fluid pressure in said reservoir is substantially unaffected by changes in pressure of said fluid source;
an air vent valve in communication with said fluid chamber to vent air from said fluid chamber;
said plunger moving outward when force from the spring overcomes force of said chain against said shoe; and
said clearance, check valve and air vent valve permitting said fluid-filled chamber to provide a substantially static reaction load when loaded by said chain.

13. The hydraulic chain tensioner assembly of claim 12, wherein said air vent valve is a piddle valve.

14. The hydraulic chain tensioner assembly of claim 12, wherein said feed orifice is characterized by a first diameter; and wherein said bleed orifice is characterized by a second diameter smaller than said first diameter.

15. The hydraulic chain tensioner assembly of claim 12, further comprising:
a plug positioned in said opening opposite said shoe and sized to further define said fluid-tight chamber; wherein said check valve is positioned on said plug; and wherein said plug has an integral passage by which said supply reservoir is in fluid communication with said check valve.

16. The hydraulic chain tensioner assembly of claim 12, wherein said plunger defines an internal reservoir between said supply reservoir and said chamber.

17. The hydraulic chain tensioner assembly of claim 12, wherein said plunger has a fill opening and at least partially forms an annular opening in fluid communication between said supply reservoir and said internal reservoir.

18. A method of manufacturing a hydraulic chain tensioner assembly comprising:
providing a tensioner body having a reservoir;
boring an opening through said tensioner body;
machining a first passage in a plug member;
machining a second passage in said plug member intersecting said first passage;
seating a check valve assembly at said second passage; and
pressing said plug member and seated check valve assembly in one end of said opening.

19. The method of claim 18, further comprising:
honing said bored opening.

20. The method of claim 18, further comprising:
sliding a plunger into an opposing end of said bored opening.
